(19) United States
(12) Patent Application Publication
(10) Pub. No.: US 2024/0020072 A1
(43) Pub. Date: Jan. 18, 2024

(54) Method of displaying real-time images and document camera system thereof

(71) Applicant: Nextedge Labs, Inc., Taipei City (TW)

(72) Inventor: Chao-Han Chang, Taipei City (TW)

(73) Assignee: Nextedge Labs, Inc., Taipei City (TW)

(21) Appl. No.: 17/982,458

(22) Filed: Nov. 7, 2022

Related U.S. Application Data
(60) Provisional application No. 63/389,947, filed on Jul. 18, 2022.

(51) Int. Cl. G06F 3/14; G06T 7/20; G06T 7/70; G06V 10/74; G06V 30/41

(52) U.S. Cl. CPC G06F 3/14; G06T 7/20; G06T 7/70; G06V 10/761; G06V 30/41; G06V 2201/07; G06T 2207/10028

(57) ABSTRACT

A method of displaying real-time images includes utilizing a document camera for capturing a raw image corresponding to a full range of a target document; detecting an object between the document camera and the target document; determining whether the object is an instruction from a user; and adjusting the raw image to be displayed on a display device according to the instruction.

### CROSS REFERENCE TO RELATED APPLICATIONS

This application claims the benefit of U.S. Provisional application No. 63/389,947, filed on Jul. 18 , 2022. The content of the application is incorporated herein by reference.

### BACKGROUND OF THE INVENTION

### 1. Field of the Invention

The present invention relates to a method of displaying real-time images and a document camera system thereof, and more particularly, to a method of displaying real-time images and a document camera system for detecting an object as an instruction to display real-time images on a display device.

### 2. Description of the Prior Art

The demand for using document cameras for online courses, conferences or classroom lessens is constantly increasing. However, during an online course, conference or classroom lessen, there are many situations in which a document camera needs to be adjusted to ensure smooth operations. For example, when the user uses the document camera to teach in the classroom, the user must suspend present speech to move a target under the document camera or operate a mouse to adjust (zoom-in, zoom-out, magnify, or minify) the content displayed on a display device, so that the display device can clearly display any block of the target. Under this circumstance, how to help the user to adjust the content displayed on the display device simultaneously without suspending the speech has become one of the goals in the industry.

### SUMMARY OF THE INVENTION

The present invention is to provide a method of displaying real-time images and a document camera system thereof to solve the above problems.

The present invention provides a method of displaying real-time images, comprising utilizing a document camera for capturing a raw image corresponding to a full range of a target document; detecting an object between the document camera and the target document; determining whether the object is an instruction from a user; and adjusting the raw image to be displayed on a display device according to the instruction.

The present invention provides a document camera system for displaying real-time images, comprising a document camera, for capturing a raw image corresponding to a full range of a target document; a display device; a controller, coupled to the document camera and the display device; and a memory, coupled to the controller, storing a program code for instructing the controller to execute a method of displaying the real-time images, wherein the method comprises detecting an object between the document camera and the target document; determining whether the object is an instruction from a user; and adjusting the raw image to be displayed on the display device according to the instruction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a document camera system according to an embodiment of the present invention.

FIG. 1B is a schematic diagram of a document camera shown in FIG. 1A according to an embodiment of the present invention.

FIG. 2 is a flowchart of a method of displaying real-time images for the document camera system of FIG. 1A according to an embodiment of the present invention.

FIG. 3 is a schematic diagram of the document camera of FIG. 1B and a target document according to an embodiment of the present invention.

FIG. 4 is a schematic diagram of a raw image in a full range displayed on a display device according to an embodiment of the present invention.

FIG. 5 is a schematic diagram of the document camera of FIG. 1B and a target document according to another embodiment of the present invention.

FIG. 6 is schematic diagrams of exemplary images displayed on a display device of FIG. 1A according to an embodiment of the present invention.

FIG. 7 is schematic diagrams of exemplary images displayed on a display device of FIG. 1A according to another embodiment of the present invention.

FIG. 8 is a flowchart of a process of detecting whether there is an object between a document camera and a target document according to an embodiment of the present invention.

FIG. 9 is a schematic diagram of relative positions of FIG. 6 and FIG. 7 according to another embodiment of the present invention.

FIG. 10 is a schematic diagram of an augmented reality displayed on a display device of FIG. 1A according to another embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

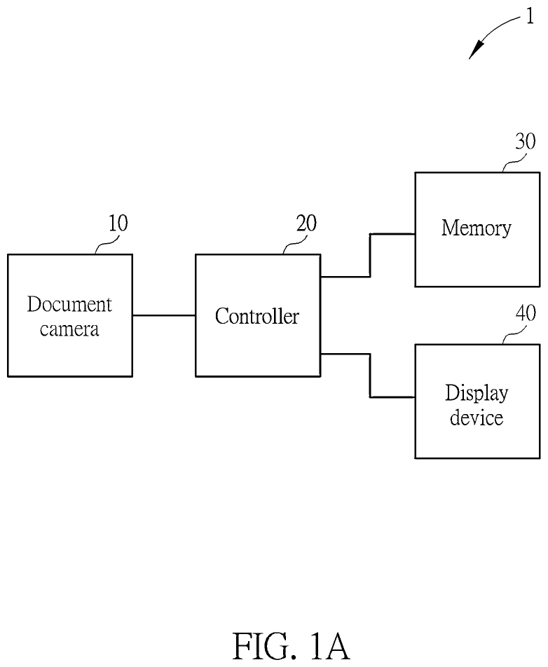

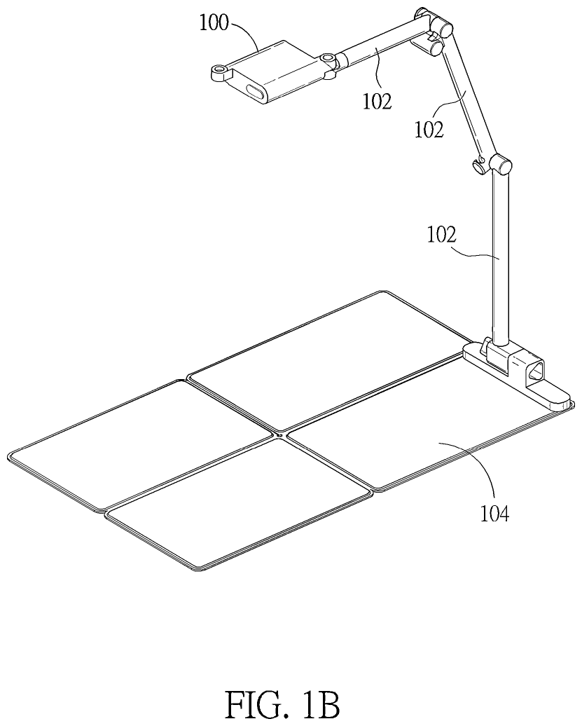

Please refer to FIG. 1A. FIG. 1A is a schematic diagram of a document camera system 1 according to an embodiment of the present invention. The document camera system 1 includes a document camera 10, a controller 20, a memory 30 and a display device 40. The document camera 10, the memory 30 and the display device 40 are coupled to the controller 20, which are used to represent basic components of the document camera system 1, but are not limited thereto. The memory 30 stores a program code for instructing the controller 20 to execute a method of displaying real-time images, so that the display device 40 displays images captured by the document camera 10 in real-time. It should be noted that the document camera system 1 represents the necessary components required for displaying real-time images, and its basic structure is well known in the art. Those skilled in the art may add other components as needed, such as the motherboard, the power supply, the cable, the microphone, the speaker, etc., but not limited thereto, or may implement the document camera system 1 with appropriate devices or apparatuses. For example, FIG. 1B is a schematic diagram of the document camera 10 according to an embodiment of the present invention. In the embodiment of FIG. 1B, the document camera 10 includes a camera lens 100, a plurality of adjustment joints 102 and a document tray 104. Users may put a document on the document tray 104, and adjust the plurality of adjustment joints 102 to make the camera lens 100 focusing on a full range of the target document 50, such that the document camera 10 may capture a raw image corresponding to the document and the raw image may be displayed on the display device 40.

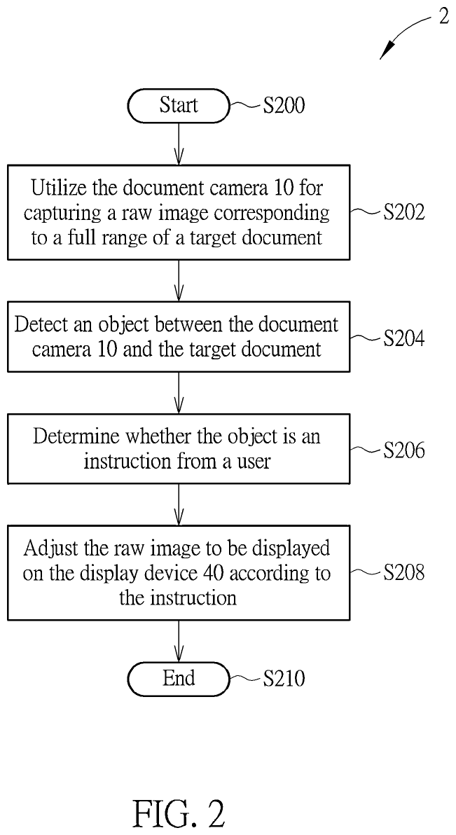

The method of displaying real-time images for the document camera system 1 may be summarized as a process 2, as shown in FIG. 2. The process 2 includes the following steps:

Step S200: Start.

Step S202: Utilize the document camera 10 for capturing a raw image corresponding to a full range of a target document.

Step S204: Detect an object between the document camera 10 and the target document.

Step S206: Determine whether the object is an instruction from a user.

Step 208: Adjust the raw image to be displayed on the display device 40 according to the instruction.

Step 210: End.

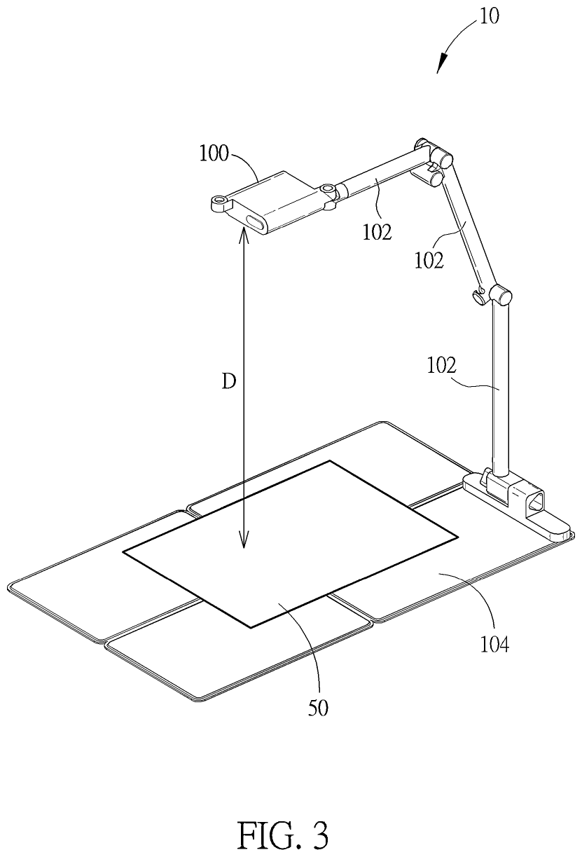

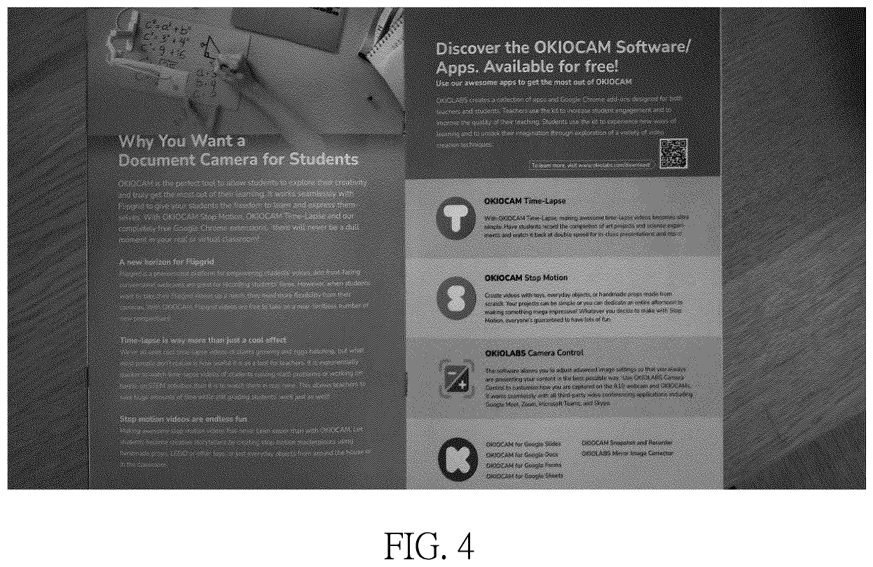

To explain the process 2, suppose that the user has put a target document 50 on the document tray 104 as shown in FIG. 3. In step S202, the document camera 10 captures a raw image corresponding to a full range of the target document 50. In detail, the user may adjust the adjustment joints 102 to make the camera lens 100 focusing on a full range of the target document 50, so that the document camera 10 may capture the raw image corresponding to the full range of the target document 50 and the raw image may be displayed on the display device 40. For example, the user may adjust a distance D between the camera lens 100 and the target document 50 to be equal to a focal length of the camera lens 100. It should be noted that the focal length of the camera lens 100 may be variable, but not limited thereto. In addition, please refer to FIG. 4, which is the raw image corresponding to the full range of the target document 50 displayed on the display device 40 according to an embodiment of the present invention. As shown in FIG. 4, the target document 50 may be a book, and the full range contains the full two pages of the book.

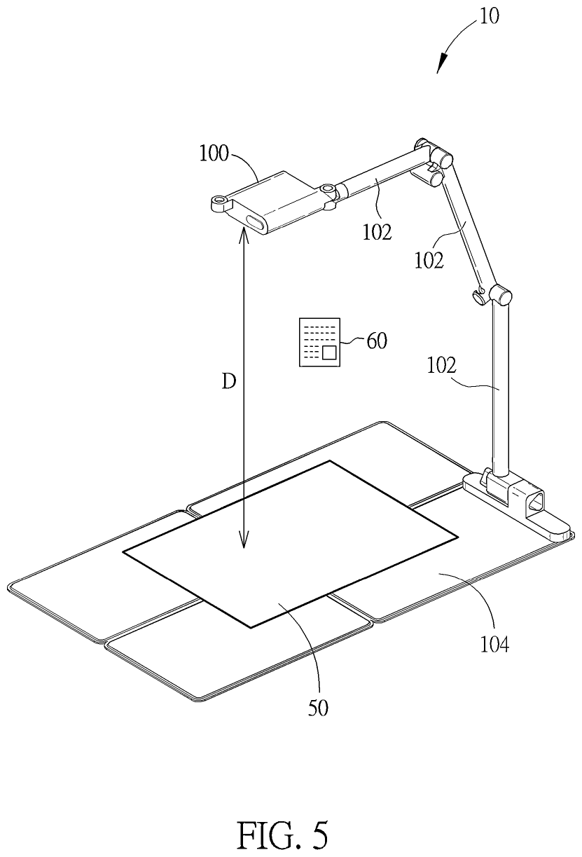

Please further refer to FIG. 5. The user may instruct to adjust the image displayed on the display device 40 by placing the object between the camera lens 100 and the target document 50. For example, the object 60 may be a specific pattern trained by AI, such as the user's finger, a pen tip, a QR-code, or a specific image. In detail, different objects may instruct different instructions, such as zoom-in/out, magnifying/minifying, counter-/clockwise rotation, but not limit thereto.

In step S204, the document camera system 1 may detect whether there is the object 60 between the camera lens 100 and the target document 50. When there is no object between the camera lens 100 and the target document 50, the document camera system 1 displays the raw image corresponding to the full range of the target document 50 on the display device 40. When there is the object 60 between the camera lens 100 and the target document 50, the document camera system 1 performs step S206.

In step S206, the document camera system 1 may determine whether the object 60 is the instruction from the user. When the object 60 is not one of the specific patterns preset by the document camera system 1, the document camera system 1 does not adjust the image displayed on the display device 40. In other words, the document camera system 1 displays the raw image corresponding to the full range of the target document 50 on the display device 40. When the object 60 is one of the specific patterns preset by the document camera system 1, the document camera system 1 performs step S208.

In an embodiment, as shown in FIG. 5, the object 60 is QR-code. Since QR-code is an universal standard format, a success rate of the document camera system of detecting QR-code by the document camera system 1 is closed to 100%, wherein the success rate refers to the probability of detecting the existence of the QR-code is placed between the camera lens 100 and the target document 50. In addition, an accuracy rate of determining the QR-code is 100%, wherein the accuracy rate refers to the probability that the document camera system 1 correctly identify the content of the QR-code after detecting the existence of the QR-code. It should be noted that, the higher the success rate and the accuracy rate, the smoother the document camera system 1 performs the method of displaying real-time images.

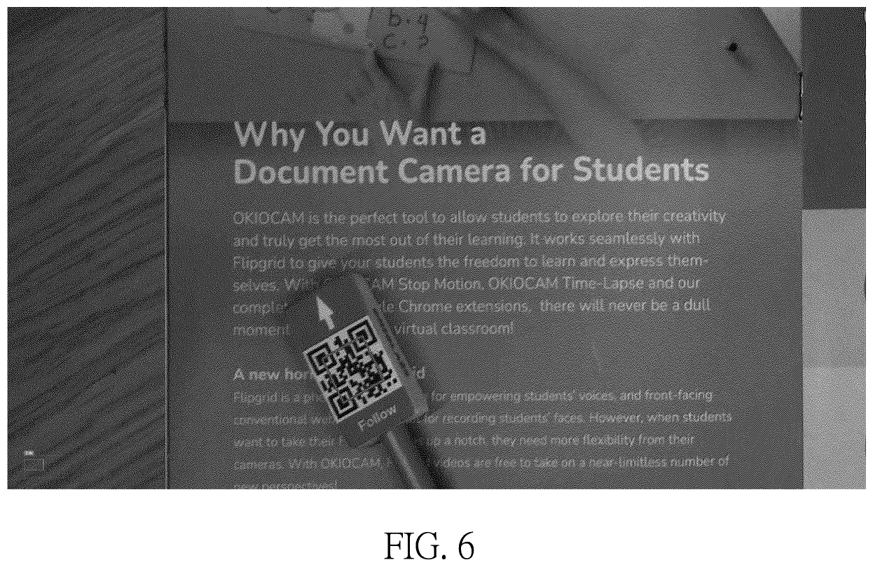

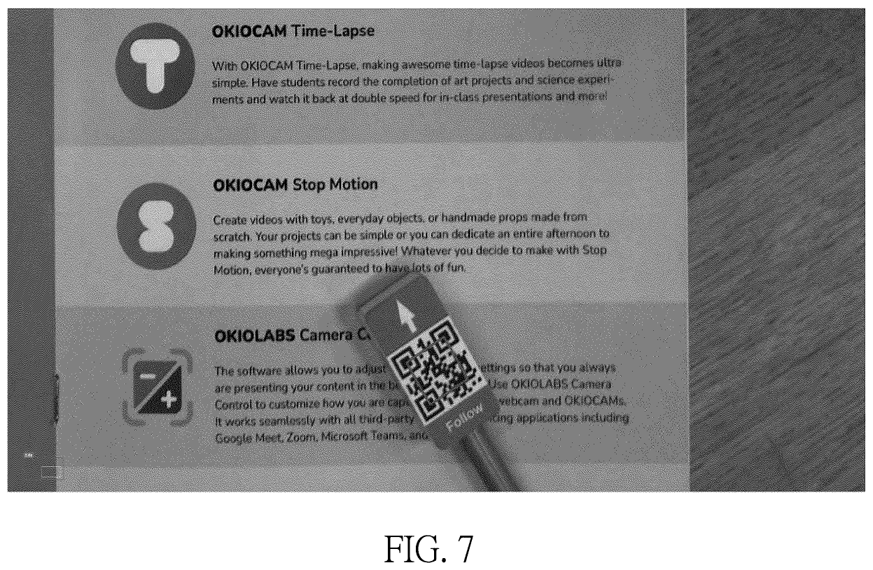

In step S208, the document camera system 1 adjusts the image displayed on the display device 40 according to the instruction corresponding to the specific pattern of the object 60. For example, the instruction may be magnifying the raw image. Please refer to FIG. 6 and FIG. 7, the document camera system 1 magnifies the raw image according to a position of the object 60 and displays on the display device 40. In this way, the user may adjust the image displayed on the display device 40 without suspending the explanation of the target document 50.

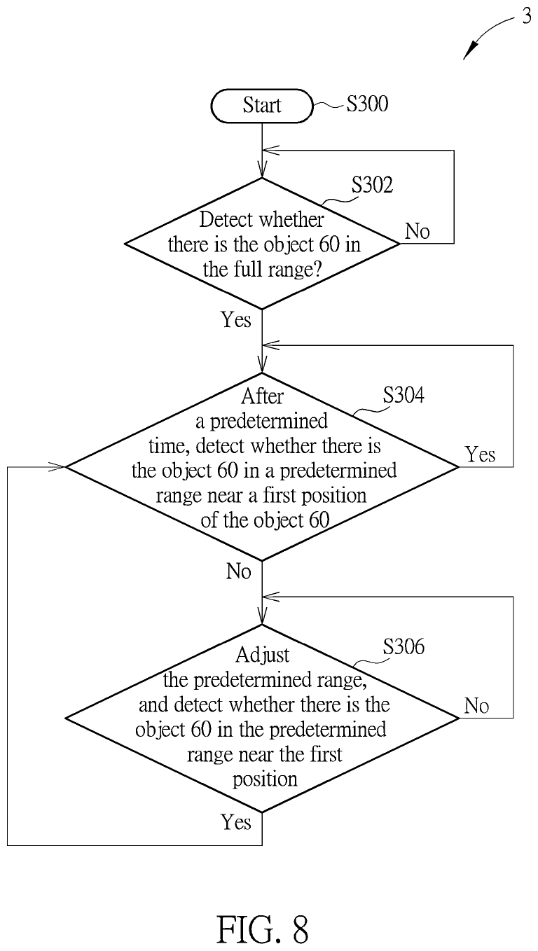

In one embodiment, the step of detecting whether there is the object 60 between the document camera 10 and the target document 50 may be summarized as a process 3, as shown in FIG. 8. The process 3 includes the following steps:

Step S300: Start.

Step S302: Detect whether there is the object 60 in the full range. If yes, go to step S304; else, repeat step S302.

Step S304: After a predetermined time, detect whether there is the object 60 in a predetermined range near a first position of the object 60. If yes, repeat step S304; else, go to step S306.

Step S306: Adjust the predetermined range, and detect whether there is the object 60 in the predetermined range near the first position. If yes, go to step S304; else, repeat step S306.

In step S302, the document camera system 1 may detect whether there is the object 60 between the camera lens 100 and the target document 50 in the full range corresponding to the target document 50. When there is no object in the full range, after the predetermined time, the document camera system 1 performs step S302. When the object 60 is at the first position within the full range, the document camera system 1 performs step S304.

In step S304, because the object 60 is at the first position within the full range, it is expected that the object 60 is still near the first position after the predetermined time, so that the document camera system 1 detects whether there is the object 60 at a second position within the predetermined range near the first position. It should be noted that the predetermined range is smaller than the full range. In detail, when the object 60 is at the second position within the predetermined range near the first position, the document camera system 1 performs step S304 again after the predetermined time. In other words, the object 60 moves from the first position to the second position. Conversely, when there is no object in the predetermined range near the first position, the document camera system 1 performs step S306.

In step S306, the document camera system 1 adjusts and increases the predetermined range near the first position. The document camera system 1 detects whether there is the object 60 at the second position within an increased predetermined range near the first position. When there is no object in the increased predetermined range near the first position, the document camera system 1 performs step S306 again. Conversely, when the object 60 is at the second position within the increased predetermined range near the first position, the document camera system 1 performs step S304. In other words, the object 60 moves from the first position to the second position.

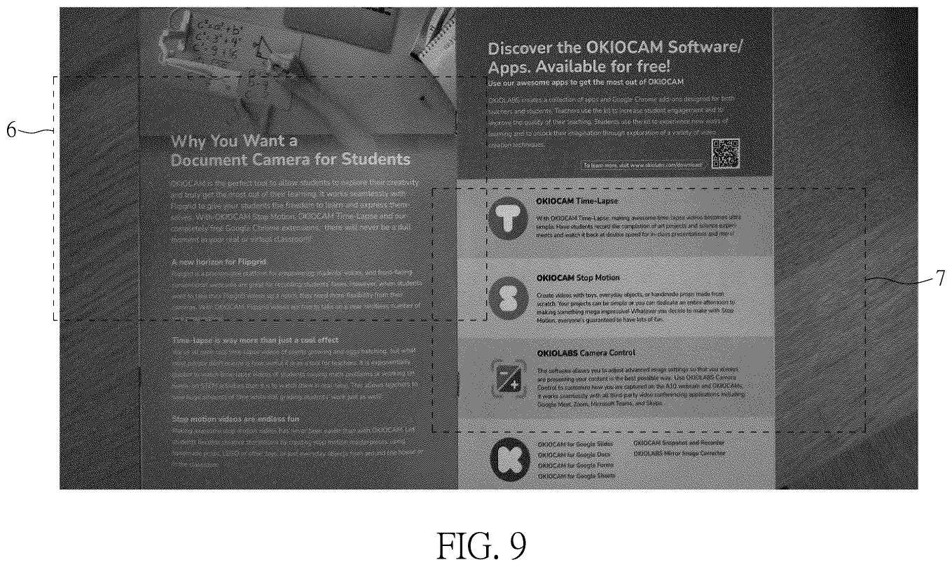

Specifically, after the object 60 is detected, the document camera system 1 may determine whether the object is the instruction from the user, and adjust the raw image as a first image according to the first position and the instruction. After a predetermined time, the document camera system 1 may adjust the raw image as a second image according to the second position and the instruction. For example, please refer to FIG. 6 and FIG. 7. As shown in FIG. 6, the object 60 is at the first position. The document camera system 1 magnifies the raw image to the first image, and displays the first image that corresponds to a zooming-in range centered on the first position on the display device 40. As shown in FIG. 7, the object 60 moves from the first position to the second position. The document camera system 1 zooms in the raw image to the second image, and displays the second image that corresponds to the zooming-in range centered on the second position on the display device 40. For example, please refer to FIG. 9. FIG. 9 shows relative positions of the embodiments of FIG. 6 and FIG. 7 in the full range of the target document 50. It should be noted that when the object 60 is recognized, the image displayed by the display device 40 may slowly be moved from the first position to the second position, as if the image moves and tracks the object 60.

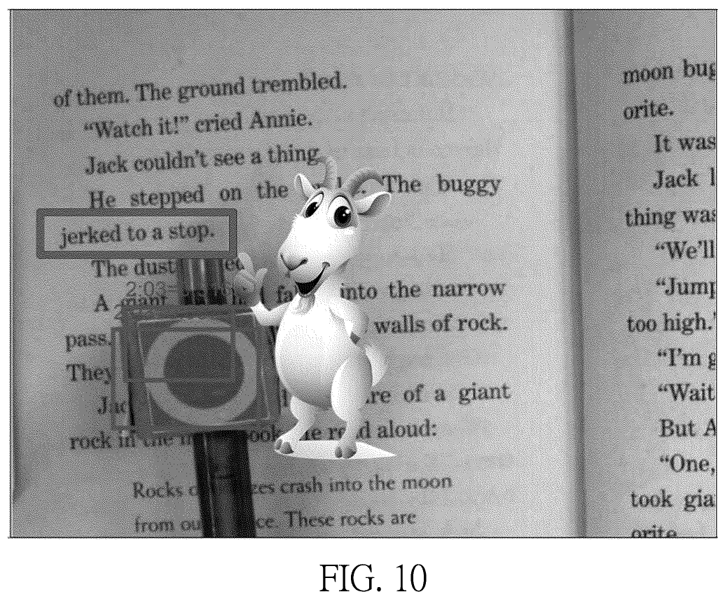

In another embodiment, please refer to FIG. 10. The document camera system 1 may display an augmented reality on the first image and the second image according to the instruction. It should be noted that the augmented reality is not limited to the animal patterns in FIG. 10.

It should be noted that the document camera system 1 is an embodiment of the present invention. Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, or combination thereof. Examples of hardware can include analog, digital and mixed circuits known as microcircuit, microchip, or silicon chip. Examples of the electronic system may include a system on chip (SoC), system in package (SiP), a computer on module (CoM) and the document camera system 1. Any of the abovementioned procedures and examples above may be compiled into program codes or instructions that are stored in the memory 30. The memory 30 may include read-only memory (ROM), flash memory, random access memory (RAM), subscriber identity module (SIM), hard disk, or CD-ROM/DVD-ROM/BD-ROM, but not limited thereto. The controller 20 may read and execute the program codes or the instructions stored in the memory 30 for realizing the abovementioned functions.

In summary, the document camera system of the present invention may detect objects as instructions and adjust the image to display on the display device. Therefore, the user may instruct to adjust the image displayed on the display device by placing the object between the document camera and the target document without suspending the explanation to the target document.

Those skilled in the art will readily observe that numerous modifications and alterations of the device and method may be made while retaining the teachings of the invention. Accordingly, the above disclosure should be construed as limited only by the metes and bounds of the appended claims.

1. A method of displaying real-time images, comprising:
utilizing a document camera for capturing a raw image corresponding to a full range of a target document;
detecting an object between the document camera and the target document;
determining whether the object is an instruction from a user; and
adjusting the raw image to be displayed on a display device according to the instruction.

2. The method of claim 1, wherein the step of utilizing the document camera for capturing the raw image corresponding to the full range of the target document comprises:
adjusting a distance between the document camera and the target document to focus on the target document and determine the full range.

3. The method of claim 1, wherein the instruction indicates magnifying or minifying the raw image.

4. The method of claim 3, wherein the object is a QR-code.

5. The method of claim 1, wherein the step of detecting the object between the document camera and the target document comprises:
detecting a first position of the object in the full range of the target document; and
after a predetermined time, detecting whether the object moves to a second position in the full range of the target document.

6. The method of claim 5, wherein the step of detecting whether the object moves to the second position in the full range of the target document comprises:
detecting whether the object is within a predetermined range centered on the first position;
when the object is not within the predetermined range, adjusting the predetermined range and performing the step of detecting whether the object moves to the second position in the full range of the target document; and
when the object is within the predetermined range, determining the object moves from the first position to the second position.

7. The method of claim 6, wherein the step of adjusting the raw image to be displayed on the display device according to the instruction comprises:
adjusting the raw image as a first image according to the first position and the instruction, and displaying the first image on the display device; and
after a predetermined time, adjusting the raw image as a second image according to the second position and the instruction, and displaying the first image on the display device.

8. The method of claim 7, further comprising:
displaying an augmented reality on the first image and the second image according to the instruction.

9. The method of claim 7, wherein the first image corresponds to an indicated range centered on the first position in the full range, and the second image corresponds to the indicated range centered on the second position in the full range.

10. A document camera system for displaying real-time images, comprising:
a document camera, for capturing a raw image corresponding to a full range of a target document;
a display device;
a controller, coupled to the document camera and the display device; and
a memory, coupled to the controller, storing a program code for instructing the controller to execute a method of displaying the real-time images, wherein the method comprises:
detecting an object between the document camera and the target document;
determining whether the object is an instruction from a user; and
adjusting the raw image to be displayed on the display device according to the instruction.

11. The document camera system of claim 10, wherein a distance between the document camera and the target document is adjusted so that the document camera focuses on the target document and the full range of the target document is determined.

12. The document camera system of claim 10, wherein the instruction indicates magnifying or minifying the raw image.

13. The document camera system of claim 12, wherein the object is a QR-code.

14. The document camera system of claim 10, wherein the step of detecting the object between the document camera and the target document comprises:
detecting a first position of the object in the full range of the target document; and
after a predetermined time, detecting whether the object moves to a second position in the full range of the target document.

15. The document camera system of claim 14, wherein the step of detecting whether the object moves to the second position in the full range of the target document comprises:
detecting whether the object is within a predetermined range centered on the first position;
when the object is not within the predetermined range, adjusting the predetermined range and performing the step of detecting whether the object moves to the second position in the full range of the target document; and
when the object is within the predetermined range, determining the object moves from the first position to the second position.

16. The document camera system of claim 15, wherein the step of adjusting the raw image to be displayed on the display device according to the instruction comprises:
adjusting the raw image as a first image according to the first position and the instruction, and displaying the first image on the display device; and
after a predetermined time, adjusting the raw image as a second image according to the second position and the instruction, and displaying the first image on the display device.

17. The document camera system of claim 16, wherein the method further comprises:
displaying an augmented reality on the first image and the second image according to the instruction.

18. The document camera system of claim 16, wherein the first image corresponds to an indicated range centered on the first position in the full range, and the second image corresponds to the indicated range centered on the second position in the full range.
